(19) United States
(12) Patent Application Publication
(10) Pub. No.: US 2022/0339907 A1
(43) Pub. Date: Oct. 27, 2022

(54) METHOD AND MACHINE FOR PRODUCING MULTI-PLY CELLULOSE MATERIAL, AND MATERIAL PRODUCED

(71) Applicant: Korber Tissue S.p.A., Lucca (IT)

(72) Inventors: Graziano Mazzaccherini, Porcari (IT); Andrea Petrone, Lucca (IT); Matteo Galoppini, Lucca (IT)

(73) Assignee: Korber Tissue S.p.A., Lucca (IT)

(21) Appl. No.: 17/763,769

(22) PCT Filed: Sep. 24, 2020
(86) PCT No.: PCT/EP2020/076791

§ 371 Date: Mar. 25, 2022

(30) Foreign Application Priority Data
Sep. 27, 2019 (IT) 102019000017369

(51) Int. Cl. B32B 7/05; B32B 29/00; B32B 3/30; B32B 3/28; B31F 1/07

(52) U.S. Cl. CPC B32B 7/05; B32B 29/005; B32B 3/30; B32B 3/28; B31F 1/07; B32B 2250/26; B32B 2250/02; B31F 2201/0733; B31F 2201/0738; B31F 2201/0748; B31F 2201/0764; B31F 2201/0789; B31F 2201/0782

(57) ABSTRACT

For bonding together two or more plies of cellulose fibers, the plies are fed to a lamination nip between a ply-bonding rotating element and an anvil element. The ply-bonding rotating element has rollers with a cylindrical surface provided with small protuberances co-acting with larger protuberances provided on a cylindrical surface of the anvil rotating element. The plies are bonded, if necessary with the aid of a functional fluid, not containing adhesive, due to the effect of the pressure between the protuberances.

### TECHNICAL FIELD

The present invention relates to improvements to the methods and devices for producing multi-ply cellulose web materials, as well as to products manufactured through these methods and devices.

### BACKGROUND

In the tissue paper producing and converting sector, to produce articles of manufacture such as rolls of toilet paper, kitchen towels, napkins, handkerchiefs and the like, it is well known to unwind a plurality of plies of cellulose fibers from one or more master rolls, and convert the plies into a semi-finished or finished product, comprising two or more plies bonded together.

For producing a multi-ply web material, the plies of cellulose fibers are often bonded together using glue. To this end, at least a ply of cellulose fibers is embossed through an embossing roller and a pressure roller, typically coated with an elastically yielding material. Embossing permanently deforms the ply of cellulose fibers, thus forming embossing protuberances thereon. The glue is applied to the embossing protuberances whilst the ply of cellulose fibers still adheres to the embossing roller. Then, a second ply of cellulose fibers is put over the first embossed ply of cellulose fibers, and the two plies are pressed against each other at the areas where glue has been applied, so as to make them adhere to one another.

The use of glue has many drawbacks. First of all, it is a consumable affecting the final cost of the multi-ply product. Moreover, it can dirt mechanical components of converting lines, first of all the embossing rollers. Cleaning interventions are in this case necessary, adversely affecting productivity. Also, the quality of the finished product is negatively affected by the use of glue that can decrease softness thereof and tactile features in general. As it is well known, glues are also usually polluting, and the use thereof has a high environmental impact. Further, not negligible problems are also due to the fact that, when for any reason the converting line stops, the glue inside it tends to dry, with consequent troubles when starting the line again.

Methods that do not require the use of glue have been therefore developed for bonding plies of cellulose fibers. These methods are substantially mechanical ply-bonding methods, wherein the plies of cellulose fibers to be bonded go through two rotating members, defining a lamination nip therebetween. Typically, one of the two rotating members is smooth and the other is engraved. The high-pressure force of the bonding members pressed against each other results in a so-called “autogenous bonding”, i.e. bonding without using glue. Sometimes, this is also called “crimp bonding”.

In order to improve the efficiency of this bonding, at least one of the plies of cellulose fibers is moistened, so that the plies better bond together. To this end, a functional fluid is used, usually a water-based one. Functional fluid means, in this case, a non-adhesive fluid, i.e. a fluid not containing glues. Beyond simple water, the use of water-soluble polyhydroxy compounds has been suggested, such as glycerol and polyglycerols, as well as polyoxyethylene and polyoxypropylene. Examples of methods and devices using this technology are disclosed in U.S. Pat. No. 6,572,722. Water, or any other functional fluid, is able to promote formation of hydrogen bonds between the cellulose fibers.

In order to reduce the negative impact of the functional fluid on the strength of the ply of cellulose fibers, the fluid can be applied only to localized areas, typically along longitudinal strips of limited width, as described in the patent document EP 1853419.

Nowadays, the efficiency of mechanical ply-bonding, with or without using functional fluid, is not completely satisfactory, especially in the case of tissue paper to be used for products such as kitchen towels and the like, as the plies of cellulose fibers contain wet-resistant resins for increasing the mechanical strength of the plies when used with liquids.

Mechanical ply-bonding has also limits as regards the appearance of the product, thus adversely affecting the attractiveness of the finished product for the end user.

There is therefore the need for improving mechanical ply-bonding techniques without the use of glues, i.e. autogenous bonding techniques, for having a better product from both functional and aesthetic viewpoint.

### SUMMARY

Before describing the features of the various embodiments of the method, the device, and the product of the invention, some definitions are provided below.

In this document, as mentioned above, “autogenous bonding” means bonding two or more plies of cellulose fibers without using glue and mainly mechanically. Autogenous bonding is obtained thanks to at least a localized pressure between opposite hard surfaces, typically metal surfaces, between which two or more plies of cellulose fibers are fed. In addition to pressure, also other factors can be used for improving autogenous bonding, such as typically a functional fluid, for example water or a water-based fluid, and/or heat.

“Functional fluid” refers to a fluid, mainly a water-based fluid, devoid of glue and adapted to improve or to promote mutual bonding of cellulose fiber plies.

The term “embossing” indicates the process of permanently deforming a portion of a cellulose structure, such as a ply or a multi-ply sheet, orthogonally to the lying plane thereof, through which the cellulose structure is permanently deformed, forming protuberances or projections projecting outside the normal lying plane of the cellulose structure, for example the lying plane of the ply or of the multi-ply web material, in case a multi-ply material is embossed.

According to a first aspect, a method is provided for producing a multi-ply cellulose web material, comprising the step of making at least two plies of cellulose fibers, put over each other, go through a lamination nip of a pressure ply-bonding device. The lamination nip is defined between: (a) a ply-bonding rotating element having at least one cylindrical surface with a plurality of first protuberances extending from the at least one cylindrical surface, each first protuberance having a side surface and a head surface; and (b) an anvil rotating element, having a cylindrical surface with a plurality of second protuberances extending from the cylindrical surface, each second protuberance having a side surface and a head surface; wherein the head surfaces of the second protuberances have multiple extension with respect to an extension of the head surfaces of the first protuberances. The method also comprises the step of pressing, in the lamination nip, the head surfaces of at least some of the first protuberances against each head surface of the second protuberances, and of bonding together by pressure the plies of cellulose fibers forming ply-bonding areas corresponding to the head surfaces of the second protuberances, each ply-bonding area comprising a plurality of bonding spots corresponding to the head surfaces of the first protuberances.

According to a further aspect, a device is provided for producing a multi-ply cellulose web material comprising a plurality of plies of cellulose fibers bonded together by means of autogenous bonding. The device comprises a ply-bonding rotating element having at least one cylindrical surface with a plurality of first protuberances extending from the at least one cylindrical surface. Each first protuberance has a side surface and a head surface. The device also comprises an anvil rotating element having a cylindrical surface with a plurality of second protuberances extending from the cylindrical surface. Each second protuberance has a side surface and a head surface. The head surfaces of the second protuberances have multiple extension with respect to an extension of the head surfaces of the first protuberances. The anvil rotating element and the ply-bonding rotating element form at least one lamination nip, through which a feeding path for the plies of cellulose fibers extends. The device also comprises pressure members for pressing the anvil rotating element and the ply-bonding rotating element against each other, so that between the first protuberances and the second protuberances a pressure is generated, adapted to promote autogenous bonding of the plies of cellulose fibers.

According to a further aspect, a further object of the invention is a sheet product comprising a plurality of plies of cellulose fibers that are bonded together by means of autogenous bonding, wherein autogenous bonding spots are grouped into discrete ply-bonding areas, spaced from one another.

Further features and embodiments of the product, the method, and the device of the present invention will be described hereunder and are set forth in the attached claims, which form an integral part of the present description.

### BRIEF DESCRIPTION OF THE DRAWING

The invention will be better understood by following the description below and the attached drawing, showing a non-limiting embodiment of the invention. More specifically, in the drawing:

FIG. 1 is a schematic side view of an embodiment of a device for autogenous bonding of plies of cellulose fibers according to the invention;

FIG. 1A shows an enlargement of the detail I_{A} of FIG. 1;

FIG. 1B shows an enlargement of the detail I_{B} of FIG. 1;

FIG. 2 is an isometric view of an embodiment of the ply-bonding rotating element;

FIG. 3 shows an enlargement of a surface portion of a roller of the ply-bonding rotating element;

FIGS. 4A and 4B show enlarged cross-sections according to the line IV-IV of FIG. 3 in two embodiments;

FIG. 5 is a plan view of an enlarged surface portion of an anvil rotating element in an embodiment;

FIG. 6 is a plan view of an enlarged surface portion of an anvil rotating element in a further embodiment;

FIG. 7 shows an enlargement of a lamination nip;

FIG. 8A is a plan view of a portion of multi-ply web material produced through an anvil rotating element as shown in FIG. 5;

FIG. 8B shows a portion of multi-ply web material produced through an anvil rotating element as shown in FIG. 6;

FIG. 9 shows a schematic enlargement of a cross-section according to the line IX-IX of FIGS. 8A and 8B;

FIG. 10 shows a schematic enlargement of a cross-section analogous to that of FIG. 9 in a further embodiment;

FIG. 11 is a schematic side view of a further embodiment of a device for autogenous bonding of plies of cellulose fibers according to the invention;

FIG. 12 shows a schematic enlarged cross-section of a web material that can be produced through the device of FIG. 11;

FIG. 13 is a schematic side view of a further embodiment of a device for autogenous bonding of plies of cellulose fibers according to the invention;

FIG. 14 a schematic side view of a further embodiment of a device for autogenous bonding of plies of cellulose fibers according to the invention;

FIG. 15 is a schematic side view of a further embodiment of a device for autogenous bonding of plies of cellulose fibers according to the invention; and

FIG. 16 is a schematic side view of a further embodiment of a device for autogenous bonding of plies of cellulose fibers according to the invention.

### DETAILED DESCRIPTION

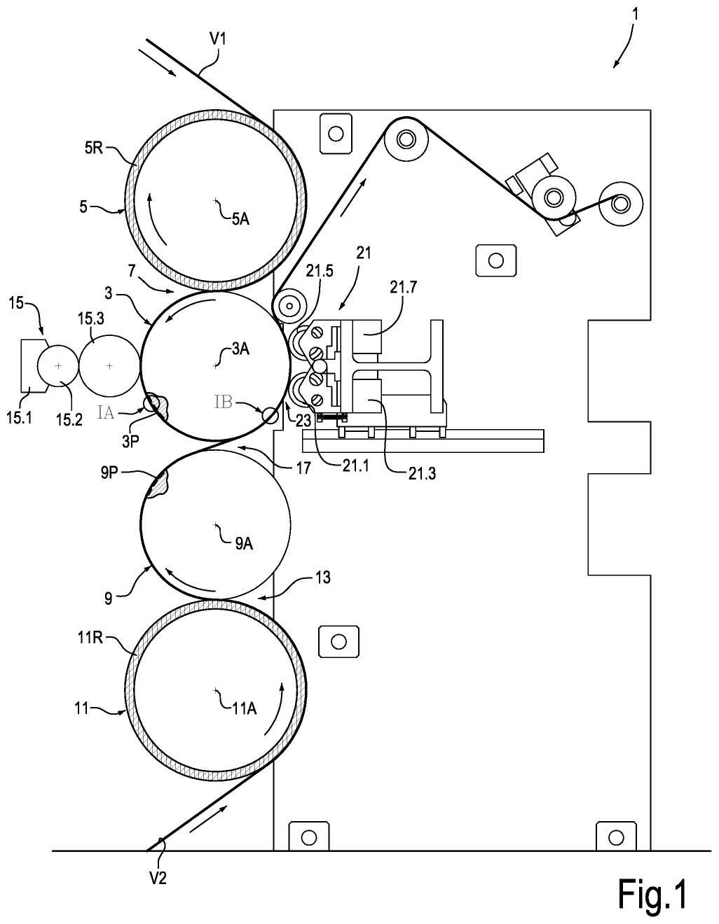

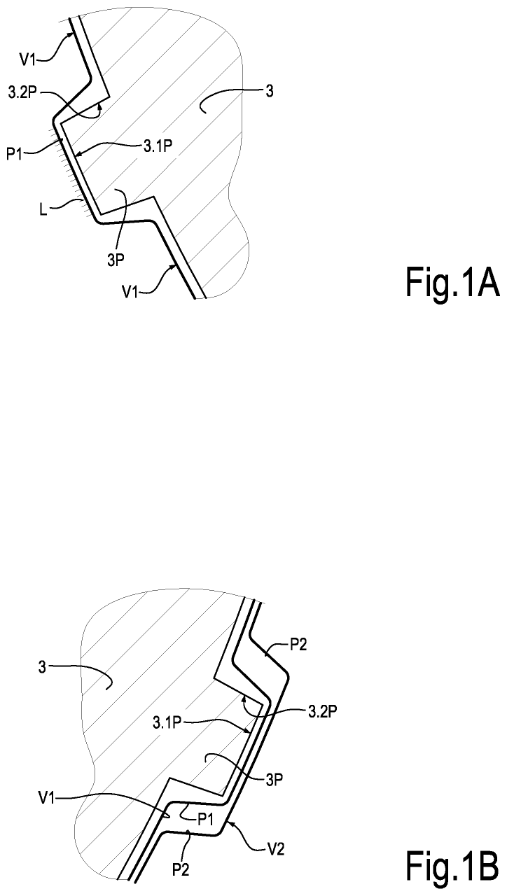

FIG. 1 is a side view of a first embodiment of a device for bonding plies of cellulose fibers, in the form of an embossing device indicated as a whole with reference number 1. The embossing device 1 comprises a first embossing roller 3 rotating around a rotation axis 3A. The cylindrical surface of the first embossing roller 3 is engraved and has a plurality of protuberances 3P. The embossing roller 3 co-acts with a first pressure roller 5 that rotates around a rotation axis 5A, approximately parallel to the rotation axis 3A. The cylindrical surface of the first pressure roller 5 is coated with an elastically yielding material 5R. The first embossing roller 3 and the first pressure roller 5 define a first embossing nip 7 therebetween.

The embossing device 1 further comprises a second embossing roller 9 rotating around a rotation axis 9A that is substantially parallel to the rotation axis 3A of the first embossing roller 3. The cylindrical surface of the second embossing roller 9 is engraved and has a plurality of protuberances 9P. The second embossing roller 9 co-acts with a second pressure roller 11 that rotates around a rotation axis 11A, approximately parallel to the rotation axis 9A. The cylindrical surface of the second pressure roller 11 is coated with an elastically yielding material 11R. A second embossing nip 13 is formed between the second embossing roller 9 and the second pressure roller 11.

In the embodiment of FIG. 1, an applicator 15, for applying a functional fluid, for instance water, containing a dye if necessary, is associated with the first embossing roller. In the embodiment illustrated in FIG. 1, the applicator 15 comprises a dispenser 15.1 for supplying functional fluid, a screen roller 15.2 and a plate roller 15.3. The screen roller 15.2 is adapted to receive functional fluid from the dispenser 15.1 and to transfer the functional fluid to the plate roller 15.3. This latter may be coated with an elastically yielding material and transfers the functional fluid to a ply of cellulose fibers fed around the first embossing roller 3, as detailed below.

In advantageous embodiments, the first embossing roller 3 and the second embossing roller 9 may be made of metal, for example steel. The surface of the metal may be hardened. The embossing protuberances 3P and 9P of the embossing rollers 3 and 9 may be produced in any suitable manner, for example by means of chemical etching, laser engraving, chip removal through a tool, or in any other suitable manner. The surface hardening process may be limited to the embossing protuberances 3P and 9P.

A passage nip 17 is defined between the first embossing roller 3 and the second embossing roller 9 for the passage of plies V1 and V2 of cellulose fibers. The first ply V1 is fed around the first pressure roller 5, around the first embossing roller 3, through the first embossing nip 7 and between the first embossing roller 3 and the functional fluid dispenser 15. The second ply V2 is fed around the second pressure roller 11, around the second embossing roller 9, in the second embossing nip 13 and is transferred from the second embossing roller 9 to the first embossing roller 3 in the passage nip 17. In this way, the first ply V1 is embossed in the first embossing nip 7 and is fed to the passage nip 17 continuously adhering to the engraved cylindrical surface of the first embossing roller 3. Embossing causes the formation of projections on the first ply V1, which adhere to a head surface of the protuberances 3P of the first embossing roller 3. In this way, the outermost radial surfaces (with respect to the rotation axis 3A of the first embossing roller 3) receive the functional fluid supplied by the applicator 15 through the plate roller 15.3, which touches the material of the ply V1 coating the head surfaces of the protuberances 3P.

FIG. 1A shows an enlargement of the detail I_{A} of FIG. 1, where a protuberance 3P of the embossing roller 3 is illustrated by way of example, with the ply V1 deformed by embossing against the protuberance 3P. The letter L schematically indicates the functional fluid applied by the dispenser 15. The reference number 3.1P indicates a head surface of the protuberance 3P, and 3.2P indicates a side surface of the protuberance 3P. P1 indicates one of the embossed projections formed by embossing the ply V1 in the first embossing nip 7.

In the passage nip 17 the second ply V2 is detached from the second embossing roller 9 and put over the first ply V1 that is still engaged by the first embossing roller 3, as shown in the enlarged detail of FIG. 1B. Embossed projections P2, formed by embossing the ply V2 in the embossing nip 13, nest between embossed projections P1 of the first ply V1. Unembossed areas of the ply V2 rest on head surfaces 3.1P of the embossing protuberances 3P of the first embossing roller 3.

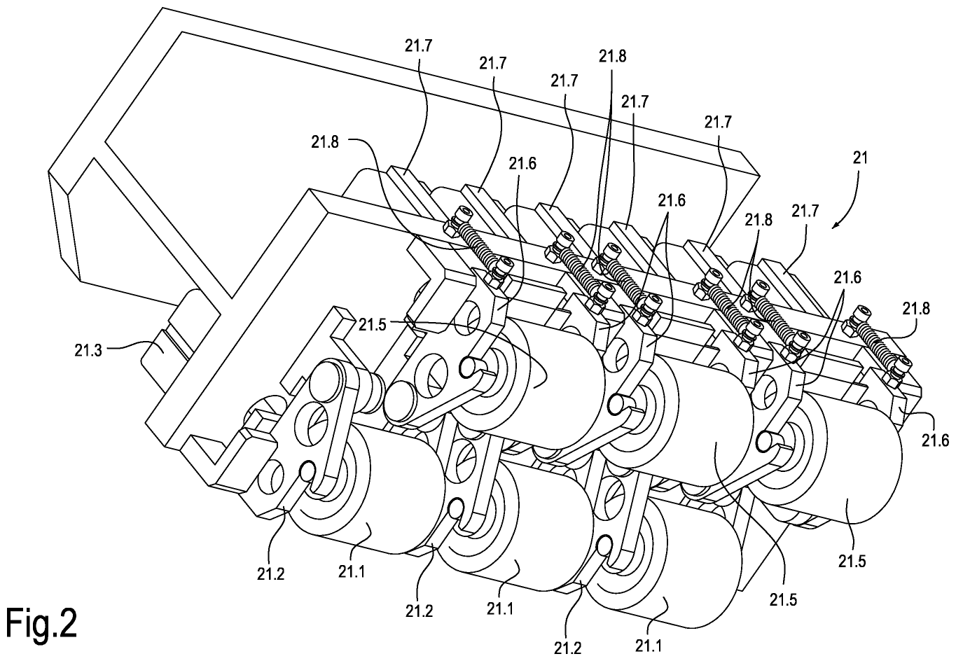

Downstream of the passage nip 17, a pressure ply-bonding rotating element 21 is provided, co-acting with the first embossing roller 3 and defining a lamination nip 23 therewith. Therefore, in this embodiment the first embossing roller 3 constitutes an anvil rotating element co-acting with the pressure ply-bonding rotating element. FIG. 2 shows a detail of the ply-bonding rotating element 21. In the illustrated embodiment, the pressure ply-bonding rotating element 21 comprises a first series of rollers 21.1 so aligned as to be approximately coaxial with one another, so installed as to rotate, preferably in idle fashion, around the respective common rotation axis. The rollers 21.1 are spaced from one another along the common rotation axis. The rollers 21.1 are supported by pivoting arms 21.2, stressed by actuators, for instance pneumatic actuators 21.3, so as to push the rollers 21.1 against the head surfaces 3.1P of the embossing protuberances 3P of the first embossing roller 3. Advantageously, the rollers 21.1 are supported independently of one another, so as to move towards the embossing roller 3 differently from one another. This allows, through preferably independent actuators 21.3, pushing each roller 21.1 against the approximately cylindrical surface of the embossing roller 3 independently of the other rollers. In this way, any deformation of the embossing roller 3, for example a deflection due to the pressure exerted by the rollers 21.1, is balanced and each roller 21.1 is pushed correctly against the embossing roller 3. Therefore, substantially the same pressure is always exerted between each roller 21.1 and the embossing roller 3, even if the axis of the embossing roller 3 is deformed due to load, or if the outer surface of the embossing roller 3 is not cylindrical but slightly convex. Due to this independent installation, the rollers 21.1 are really coaxial only if the surface of the embossing roller 3 is cylindrical. If not, the rollers 21.1 are only approximately coaxial.

In the illustrated example, the anvil rotating element 21 comprises a second series of rollers 21.5 so aligned as to be approximately coaxial with one another, so installed as to rotate, preferably in idle fashion, around the respective common rotation axis that is approximately parallel to the rotation axis of the first rollers 21.1. The second rollers 21.5 are spaced from one another along the common rotation axis. The rollers 21.5 are supported by pivoting arms 21.6, stressed by actuators, for instance pneumatic actuators 21.7, so as to push the rollers 21.5 against the head surfaces 3.1P of the embossing protuberances 3P of the first embossing roller 3. Elastic return members 21.8 tend to move the rollers 21.5 away from the surface of the embossing roller 3 against the action of the actuators 21.7. A similar arrangement of elastic return members (not shown in the drawing) can be provided for the rollers 21.1. What described for the rollers 21.1, as regards the ability of balancing deviations of the surface of the embossing roller 3 with respect to a perfectly cylindrical shape, applies also to the rollers 21.5. Consequently, also the rollers 21.5 are approximately coaxial with one another.

As shown especially in FIG. 2, the rollers 21.1 and the rollers 21.5 are offset with respect to one another. Practically, this means that each roller 21.5 is aligned with the space between two consecutive rollers 21.1, and vice versa. In this way, during the rotation of the first embossing roller 3, against which the rollers 21.1 and 21.5 are pushed, any point of the cylindrical surface of the first embossing roller 3 touches at least one of the rollers 21.1 or 21.5.

In general, the arrangement of the rollers 21.1 of the first series and the rollers 21.5 of the second series is such that any point of the active cylindrical surface of the embossing roller 3 touches the cylindrical surface of at least one of the rollers 21.1 and 21.5. In this document, “active cylindrical surface of the embossing roller 3” indicates the engraved cylindrical surface, i.e. the surface provided with embossing protuberances 3P, useful for embossing the web material. The active cylindrical surface has an axial extension equal to at least the width of the ply V1 of maximum transverse dimension that can be processed by means of the embossing roller 3.

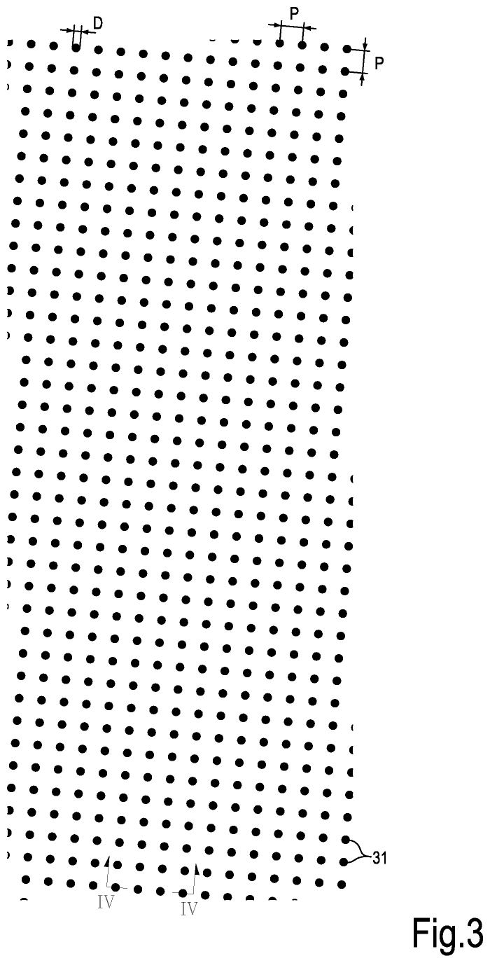

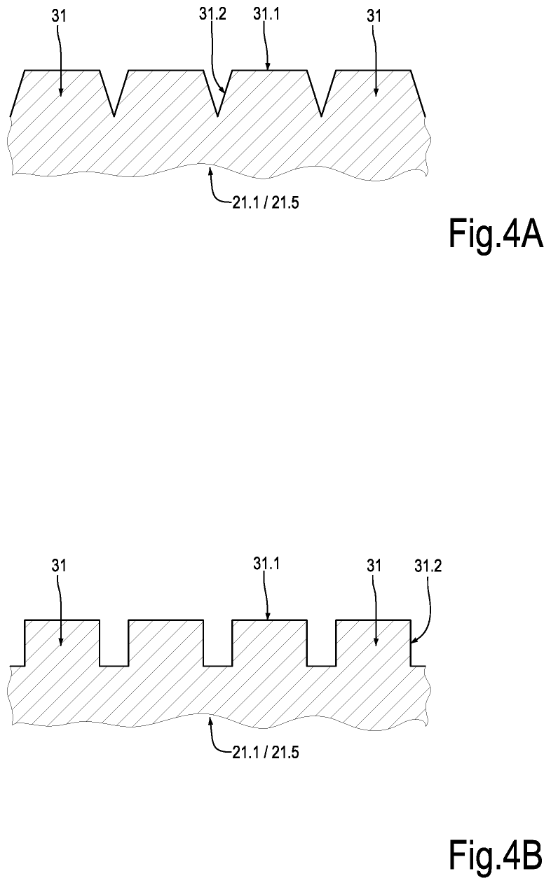

The rollers 21.1 and 21.5 have engraved cylindrical surfaces with a plurality of protuberances. These protuberances have preferably a simple geometrical shape and are substantially dot-shaped. The protuberances of the rollers 21.1 and 21.5 may be for example truncated-pyramidal, truncated-conical, or simply cylindrical or prismatic. FIG. 3 is an enlarged plan view of a portion of the cylindrical surface of one of the rollers 21.1 and 21.5. In this embodiment, the rollers 21.1 and 21.5 are provided with protuberances 31, of truncated-conical or cylindrical shape, with a round head surface. FIG. 4A shows an enlarged cross-section according to the line IV-IV of FIG. 3 of a group of these protuberances 31 of truncated-conical shape. FIG. 4B shows a similar cross-section, where the protuberances 31 are cylindrical in shape. Each protuberance 31 comprises a head surface 31.1 and a side surface 31.2. Advantageously, the head surface 31.1 of each protuberance 31 is joined to the side surface 31.2 along a sharp edge, thus allowing better mechanical autogenous bonding, as explained below.

In some embodiments, the protuberances 31 are advantageously distributed according to the nodes of a matrix, for example a matrix of polygonal, typically quadrangular, and especially square, meshes, as shown in FIG. 3. In this figure, P indicates the distance between adjacent protuberances 31. As the protuberances are distributed according to the nodes of a square mesh, the distance P is the same in both the alignment directions of the protuberances, even if this is not strictly necessary. The letter D indicates the diameter of the head surfaces 31.1 of the protuberances 31.

In some embodiments, the distance P is comprised between about 0.2 mm and about 1.5 mm, in particular between about 0.5 and about 1 mm, in some embodiments for example between about 0.7 mm and about 0.9 mm.

As indicated above in the embodiment of FIG. 3, the head surface 31.1 of the protuberances 31 is round. In preferred embodiments, the diameter of the head surfaces 31.1 is smaller than about 1.5 mm, and is comprised for example between about 0.1 mm and about 1.5 mm, in particular between about 0.15 mm and about 0.7 mm. In some embodiments, the diameter of the head surfaces 31.1 is comprised between about 0.2 mm and about 0.6 mm.

In this description and the attached claims, the term “about” referred to a physical quantity indicates that the quantity is approximate, typically with an approximation of +/−10%, in some cases +/−5% of the indicated value. For example, a value of “about X” means a value comprised in the interval between (X−0.1X) and (X+0.1X), or preferably in the interval between (X−0.05X) and (X+0.05X).

As indicated above, the protuberances 31 may have a shape other than the truncated-conical shape with round cross-section illustrated in the attached drawing. The protuberances 31 may have not-round dot-shaped head surfaces 31.1, for example elliptical or polygonal, for example rectangular or square, or mixtilinear, and may have a convex or a partially concave perimeter. Independently of the shape of the head surface 31.1, it is possible to specify a maximum dimension for the head surface 31.1 of the protuberances 31. The maximum dimension is defined as the maximum distance between two points belonging to the perimeter of the head surface. If the surface is round, the maximum distance corresponds to the diameter. If the head surface is elliptical, the maximum dimension corresponds to the major axis of the ellipse. If the shape is square or rectangular or, in general, quadrangular, the maximum dimension is equal to the major diagonal. Preferably, independently of the shape of the head surface 31.1 of the protuberance 31, the maximum dimension thereof, as defined above, is preferably smaller than about 1.5 mm, in particular it is comprised between about 0.1 mm and about 1.5 mm, for instance between about 0.15 mm and about 0.7 mm. In some embodiments, the maximum dimension of the head surfaces 31.1 is comprised between about 0.2 mm and about 0.6 mm.

The area (i.e. the extension) of the head surface 31.1 of each protuberance 31 is comprised between about 0.008 mm² and about 1.8 mm², for example between about 0.07 mm² and about 0.8 mm².

In advantageous embodiments, the protuberances 31 are distributed with uniform density on all the cylindrical surfaces of the rollers 21.1 and 21.5. In general, the density of the protuberances 31 is comprised between about 20 and about 200 protuberances/cm², preferably between about 50 and about 170 protuberances/cm², for example between about 80 protuberances/cm² and about 130 protuberances/cm².

The dimensions of the protuberances 31 indicated above allow improving autogenous bonding, i.e. mechanical bonding of the plies V1 and V2 without the use of glue, thanks to the pressure between the protuberances 31 and the protuberances 3P of the embossing roller 3.

In some embodiments, the height of the protuberances 31 is comprised between about 0.1 mm and about 1 mm, preferably between about 0.2 mm and about 0.6 mm, so that the resistance to deflection and crashing is adequate to the dynamical stress conditions occurring when the protuberances 31 of the rollers 21.1 and 21.5 co-act with the protuberances 3P of the embossing roller 3.

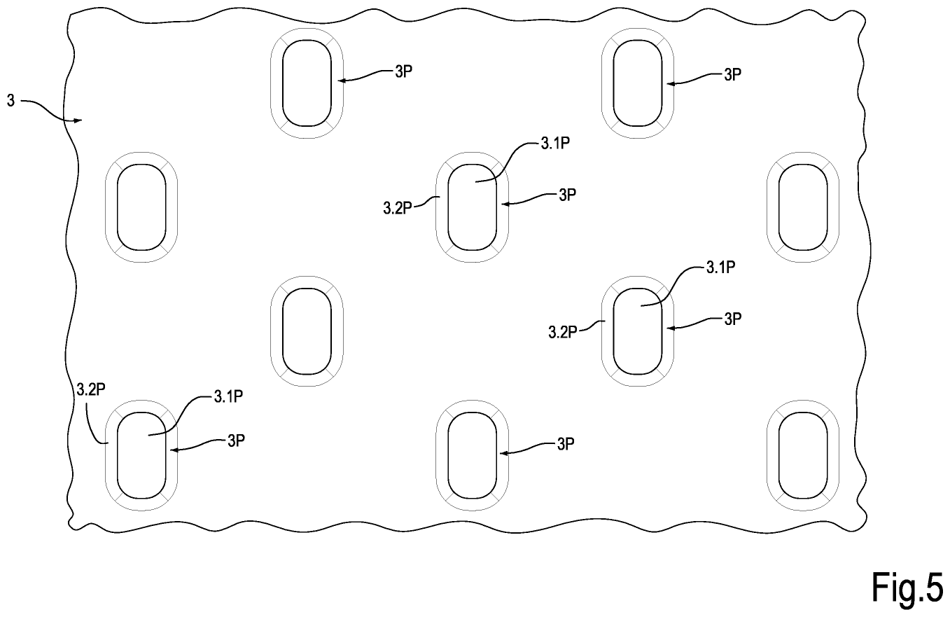

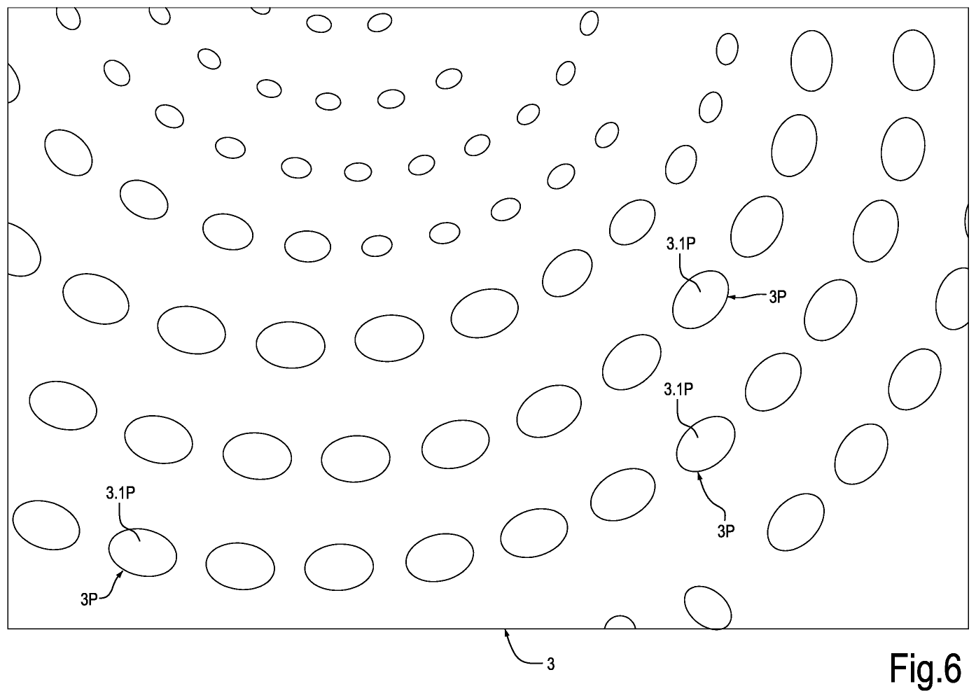

The dimensions of the protuberances 3P of the embossing roller 3 are substantially larger than the dimensions of the protuberances 31 of the rollers 21.1 and 21.5. The protuberances 3P have simple geometrical shape and are repeatedly distributed, as schematically illustrating in FIG. 5, showing a plan view of a portion of the cylindrical surface of the embossing roller 3. Alternatively, the protuberances 3P may have a more complex shape, for example to define decorative patterns. FIG. 6 is a schematic plan view similar to that of FIG. 5, where the protuberances 3P have variable shape and are arranged according to decorative patterns, for example grouped so as to form decorative linear elements. In general, the distribution of the protuberances is approximately uniform, but it may vary in areas other than the cylindrical surface of the embossing roller 3.

Therefore, “uniform” does not mean that the protuberances 3P are at the same distance from one another, but that they are so distributed as to form bonding s between the plies V1, V2 so distributed as to keep the plies adhering enough to each other. For example, protuberances may be provided defining a decorative pattern with a very low density of protuberances, and areas surrounding this decorative pattern where the density of protuberances is significantly higher. In improved configurations, the areas where the density is higher surround the areas where the density is lower. In other cases, instead of forming a main embossing decorative pattern, the protuberances may be distributed so as to form a uniform background. In further cases, the protuberances 3P are linear, i.e. with one dimension significantly larger than the other. In all cases, the maximum distance between the top of a protuberance and the other is smaller than 60 mm. In other words, the plies are bonded so as not to have unbonded areas, i.e. areas not mutually joined, of such dimensions as to cause the formation of swells due to an excessive local separation of the plies. These swells are unsightly and can cause problems in quality, as they are subjected to the formation of wrinkles in the plies and can facilitate the complete detachment of the plies.

Finally, the multi-ply embossed product obtained by bonding the plies has an approximately uniform, i.e. uniformly adhering, bonding surface, where ply-bonding areas are spaced from one another by a distance preferably not greater than about 60 mm. In other words, if a circumference with a diameter of 60 mm is centered in any protuberance 3P of the embossing roller 3, at least one further protuberance will be arranged within this circumference. Therefore, in this document “uniformly distributed ply-bonding” means bonding wherein the distance between ply-bonding areas is not greater than 60 mm.

Typically, the head surfaces 3.1P of the protuberances 3P of the embossing roller 3 are such that the area thereof is equal to a multiple of the area of the head surfaces 31.1 of the protuberances 31 of the rollers 21.1 and 21.5. In this way, in the two lamination nips 23 formed by the two series of rollers 21.1 and 21.5 with the embossing roller 3, each protuberance 3P touches and presses a plurality of protuberances 31 of at least one of the coaxial rollers 21.1 and/or 21.5.

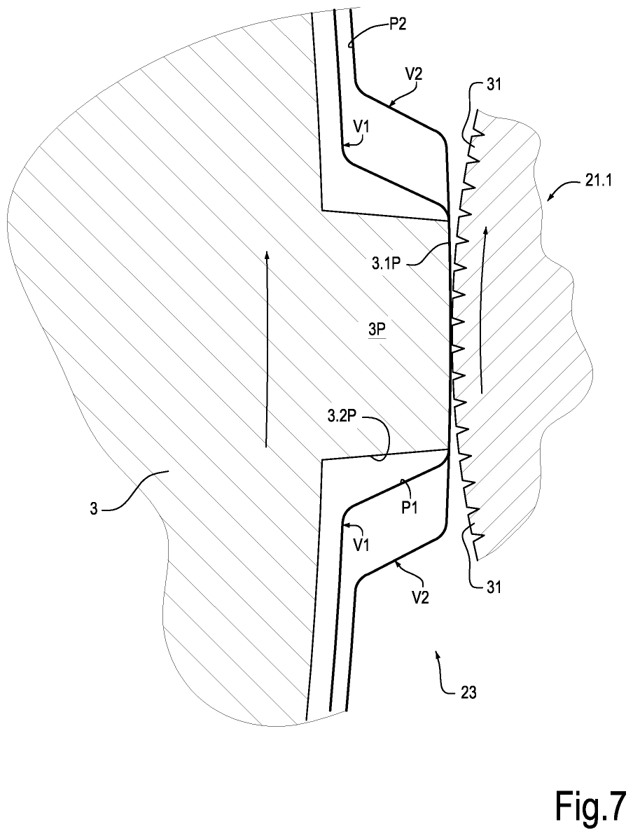

The situation occurring in each lamination nip 23 is schematically illustrated in FIG. 7, showing a schematic enlargement of an area of pressure contact between a protuberance 3P of the embossing roller 3 and a plurality of protuberances 31 of one of the rollers 21.1 (a similar situation occurs in the lamination nip between the embossing roller 3 and the rollers 21.5). The head surface 3.1P of the protuberance 3.1P has such an extension as to touch a plurality of head surfaces 31.1, for instance at least five or even more, of corresponding protuberances 31.

In this way, a localized pressure is provided between the embossing roller 3 and the rollers 21.1, 21.5, concentrated on some of the head surfaces 31.1 of the protuberances 31, i.e. the protuberances that are in phase with corresponding protuberances 3.1P of the embossing roller 3. Thanks to this configuration the plies V1, V2 are bonded by means of autogenous ply-bonding (mechanical ply-bonding or crimp bonding) along the head surfaces of the protuberances 3P where the ply V1 has been embossed. On the embossed projections of the ply V1 generated by the embossing protuberances 3P, discrete bonding spots are generated, corresponding to the plurality of protuberances 31 touching and pressing the head surfaces 3.1P of the embossing protuberances 3P.

Advantageously, the embossing protuberances 3P are distributed substantially on the whole active cylindrical surface of the embossing roller 3, so as to have autogenous bonding between the plies V1 and V2 on the whole width thereof. In some embodiments, the overall area of the head surfaces 3.1P of the embossing protuberances 3P is comprised between about 1% and about 30% of the total area of the active cylindrical surface of the embossing roller 3. Preferably, this area of the head surfaces 3.1P is comprised between about 5% and about 20% of the total area of the active surface of the embossing roller 3. As autogenous bonding between the plies V1 and V2 is localized on the head surfaces 3.1P of the embossing protuberances 3P, the percentages mentioned above for the area of the head surfaces 3.1P allow effective bonding of the plies V1 and V2.

Thanks to the fact that each head surface 3.1P of the protuberances 3P is pressed against a plurality of protuberances 31 of one or more rollers 21.1 and 21.5, the localized pressure is higher than that would be obtained, for example, if the rollers 21.1 and 21.5 were smooth. Therefore, given the same force generated by the actuators 21.3 and 21.7, higher lamination and bonding pressures for the plies V1, V2 are obtained.

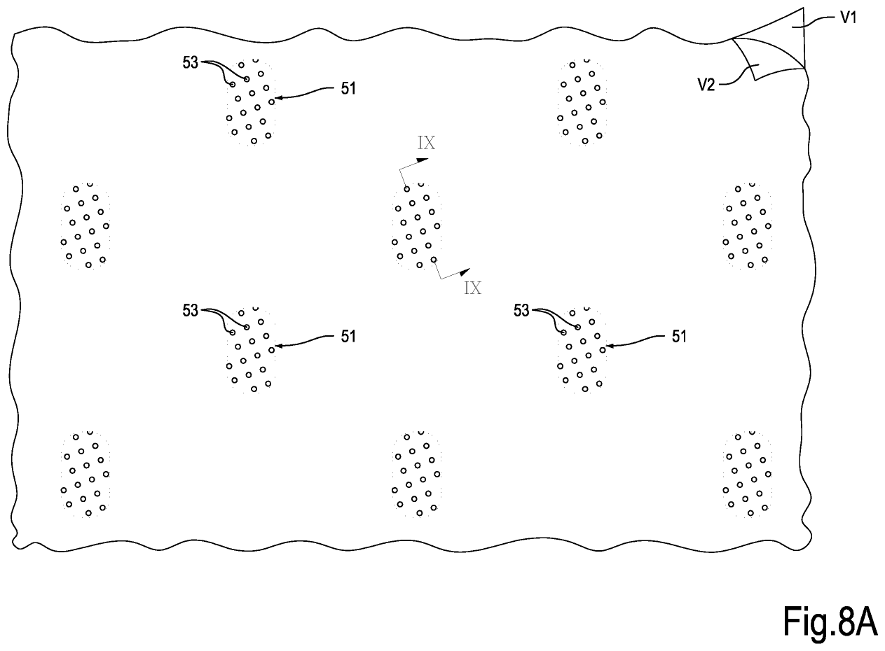

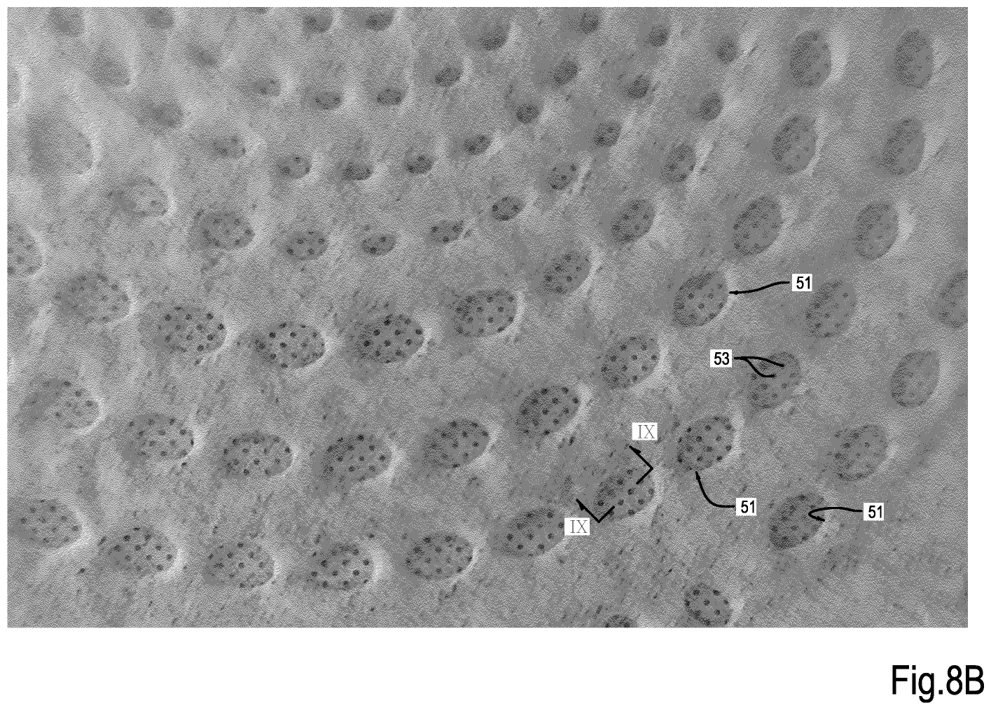

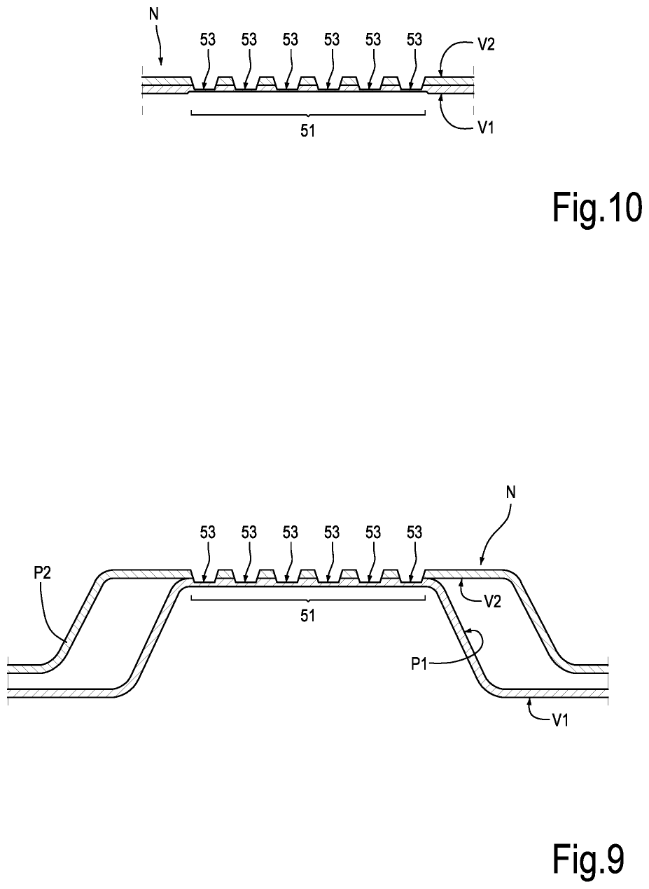

FIGS. 8A, 8B and 9 show the result of the autogenous bonding process performed through the device 1 described above. FIG. 8A is a schematic plan view of a multi-ply web material N obtained by bonding plies V1 and V2, wherein the ply V1 has been embossed with an embossing pattern of the type illustrated in FIG. 5. FIG. 8B is a schematic plan view, similar to the view of FIG. 8A, of a web material N obtained with an embossing roller 3 with a pattern of protuberances 3P as illustrated in FIG. 6.

FIG. 9 shows an enlarged schematic cross-section according to the line IX-IX of FIGS. 8A and 8B. As shown in particular in FIGS. 8A and 8B, ply-bonding areas 51 have been generated on the web material N, each area corresponding to a head surface 3.1P of a respective protuberance 3P of the embossing roller 3. Bonding spots 53 are provided in each ply-bonding area 51, each spot corresponding to a head surface 31.1 of one of the protuberances 31 of a respective roller 21.1 or 21.5. Therefore, the bonding spots 53 have approximately the same dimension and shape as the head surfaces 31.1 of the protuberances 31 that have generated them.

The ply-bonding areas 51 are the envelope of the bonding spots 53 generated at a single protuberance 3P of the embossing roller. Therefore, the ply-bonding areas 51 have approximately the same shape and extension as the head surfaces 3.1P, at which the bonding spots 53 have been formed.

As schematically shown in the enlarged cross-section of FIG. 9, the cellulose fibers forming the plies V1 and V2 have been compressed and laminated together in the bonding spots 53, with the web material N becoming thinner. In some cases, when the pressure exerted in the bonding spots 53 is significantly high, the plies V1 and V2, at the head surfaces 31.1 of the protuberances 31, are so thin as to form a single very thin translucent, or almost transparent ply of pressed cellulose fibers (“spot glassining”). This phenomenon is particularly visible in the picture of FIG. 8B.

Schematically, in FIG. 9 each bonding spot 53, corresponding to a protuberance 31, is characterized by an area of cellulose fibers thinner than the sum of the thicknesses of the two plies V1 and V2. The bonding spots 53 are autogenous bonding spots, i.e. where the plies V1 and V2 are bonded together without glue thanks to localized pressure and, if necessary, to the creation of hydrogen bonds, facilitated by the use of functional fluid, if the method has been implemented using the applicator 15. If the applicator 15 is not provided, or if it does not supply functional fluid, the two plies V1 and V2 are bonded together in the bonding spots 53 merely by the localized pressure exerted at the head surfaces 31.1 of the protuberances 31.

In FIG. 9, the reference P1 indicate the embossed projections generated on the ply V1 in the first embossing nip 7 by the embossing roller 3 and by the first pressure roller 5. Reference P2 indicates one of the embossing projections formed on the ply V2 in the second embossing nip 13, where the second ply V2 is embossed between the second embossing roller 9 and the second pressure roller 11.

In some embodiments, the embossed projections P1 and P2 are nestled inside one another, as schematically shown in FIG. 9. However, this arrangement is not mandatory.

As shown in FIGS. 8A, 8B, in the described case a technical-decorative effect is obtained on the multi-ply web material N formed by bonding the plies V1, V2, wherein the embossed projections P1 of the ply V1 define ply-bonding areas between the plies V1, V2. The bonding spots 51 are concentrated in the ply-bonding areas. The overall effect is a combined decorative pattern, given by the 3-dimensional effect of the embossing (projections P1) and the effect of the bonding spots 53, where the web material can be translucent or almost transparent, thanks to the localized pressure and the consequent fusion of cellulose fibers. A technical-functional effect is also associated with the decorative pattern: embossing increases the thickness of the web material N and the tactile features thereof; moreover, it delimits the ply-bonding areas 51 where the bonding spots 53 act as mechanical joining between the plies V1 and V2 through autogenous bonding.

The use of protuberances 31 with small head surfaces and preferably provided with a sharp edge is useful for increasing the autogenous bonding effectiveness, thanks to the high pressures achieved in the lamination area between protuberances 31 and protuberances 3P and thanks to the cut of the cellulose fibers caused by the perimeter sharp edges of the head surfaces.

In some embodiments, all embossed projections P1 of the ply V1 are bonded to the ply V2 in the respective ply-bonding areas 51 by means of bonding spots 53. However, this is not strictly necessary. For example, a part, preferably at least 20%, of the overall area of the head surfaces 3.1P of the embossing protuberances 3P may be pressed against corresponding protuberances 31. This can be done, for instance, by providing embossing protuberances 3P with variable heights, i.e. with head surfaces 3.1P at variable distance from the rotation axis of the embossing roller 3P. Only the head surfaces arranged at a greater distance from the rotation axis 3A of the embossing roller 3 touch and press the protuberances 31, whilst the other head surfaces remain distanced from the protuberances 31, so that no bonding pressure is generated. For better distributing the bonding spots between the two plies V1 and V2, preferably all embossing protuberances 3P press against respective protuberances 31.

The multi-ply web material N obtained by the method and the device of the invention is typically wound in logs that are then cut into rolls of smaller axial dimension, destined for distribution and sale to the end consumer. Moreover, before being wound the web material is perforated so as to be divided into sheets separable by tearing. In this case, it is preferable to concentrate the bonding spots between the plies V1, V2 mostly on longitudinal and/or transverse areas corresponding to the edges of a sheet of web material delimited by transverse perforation lines and by the cuts performed on the log of axial length equal to the width of the paper plies, so as to have single small logs destined for distribution and sale.

In some embodiments the ply V2 is not embossed. This can be done, for example, by modifying the path of the ply V2 with respect to that illustrated in FIG. 1. The ply V2 may be fed directly to the lamination nips 23. Alternatively, the pressure roller 11 can be deactivated, by moving it away from the embossing roller 9, so that the ply V2 is not embossed.

In other embodiments the ply V1 is not embossed. This can be done, for example, by deactivating the pressure roller 5 by moving it away from the embossing roller 3. Preferably, the functional fluid applicator 15 is kept operative and the ply V1 is therefore fed around the first embossing roller 3, in the nip between the embossing roller 3 and the plate roller 15.3 of the applicator 15.

If none of the two plies V1, V2 is embossed, the two plies V1 and V2 are bonded analogously to what described above, with ply-bonding areas 51 defined by the head surfaces 3.1P of the embossing protuberances 3P, against which protuberances 31 of one, or the other, of the rollers 21.1 and 21.5 press. However, the ply V1 is not embossed and, therefore, it has not embossed projections P1. FIG. 10 shows an enlarged schematic cross-section, similar to that of FIG. 9, of a ply-bonding area 51 with corresponding bonding spots 53 obtained when the plies V1 and V2 are not embossed. In practice, the ply-bonding area 51 is defined by the portion of ply V1 that touched the head surface 3.1P of the respective embossing protuberance 3P, but the ply V1 has not been permanently deformed by the protuberance 3P co-acting with the pressure roller 5, and it has therefore no embossed projections P1. In this case, the ply V2 is not embossed, but it is also possible to emboss it in the second embossing nip. In some cases, on the ply V1, at the head surfaces 3.1P, it is possible to cause a very small squeezing the height whereof is lower than the projections P1 and at least partially comprised within the thickness of the same ply V1.

If the ply V1 is embossed in the first embossing nip 7, the embossed projections P1 remain engaged with the respective embossing protuberances 3P up to the area where the functional fluid is applied by means of the applicator 15. In this way the functional fluid is applied only to the portions of ply V1 adhering to the head surfaces 3.1P of the protuberances 3P. In fact, these ply portions are on a cylindrical surface of larger diameter, coaxial with the axis 3A of the first embossing roller 3, and are the only portions touching the cylindrical surface of the plate roller 15.3.

If the ply V1 is not embossed, when it is fed around the embossing roller 3 it touches the head surfaces 3.1P of the embossing protuberances 3P. The ply V1 is sufficiently tensioned to provide that the portions of ply V1 touching the head surfaces 3.1P of the embossing protuberances 3P in this case again project slightly more radially towards the plate roller 15.3 so as to be, in this case again, the only projections receiving the functional fluid.

The functional fluid, if colored, in addition to promoting autogenous bonding of the plies V1 and V2 also decorates chromatically the web material N obtained by means of ply-bonding. In fact, at least the outer visible surface of the ply V1 will be colored at the embossed projections P1.

It is also possible to use an applicator 15 configured for distributing a plurality of functional fluids, each one having a different color. In this case, a greater and more various decorative chromatic effect can be obtained on the web material N.

The plies V1 and V2 may be fed to the embossing device 1 in the form of smooth plies. In other embodiments, before being fed to the embossing device 1 the ply V1, or the ply V2, or both the plies V1 and V2 are subjected to a preliminary micro-embossing step. Micro-embossing means embossing deforming the ply so as to form dot-shaped embossed projections of simple geometrical shape, for example of truncated-pyramidal or truncated-conical shape, with a density equal to, or greater than, for instance about 20 projections/cm², preferably equal to, or greater than about 50 projections/cm², more preferably equal to, or greater than about 80 projections/cm².

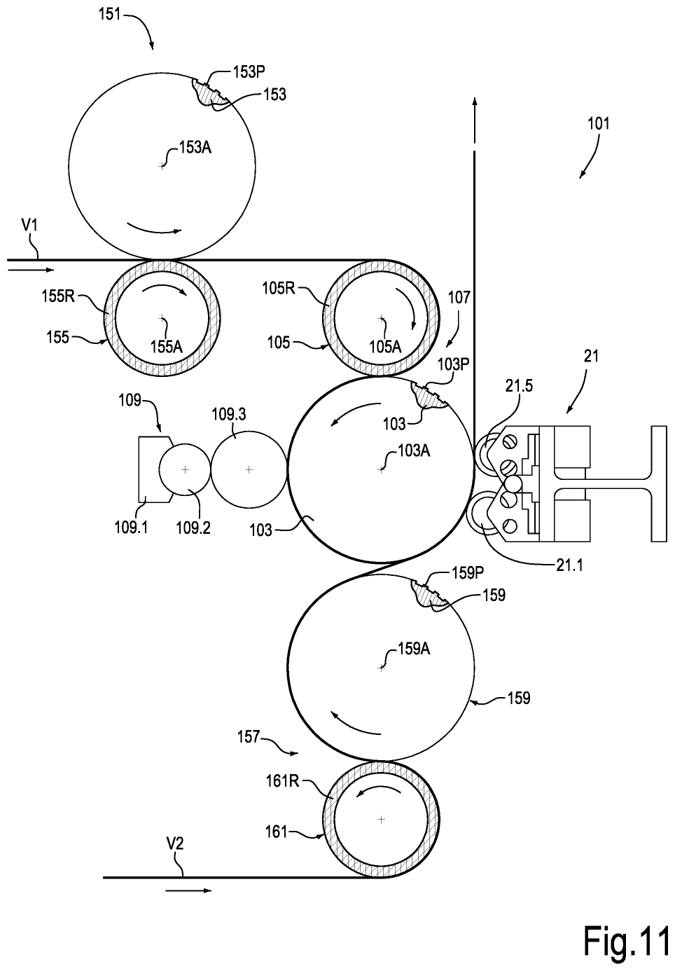

A mechanical ply-bonding method for bonding the plies of a multi-ply web material can be implemented also through devices other than that illustrated in FIG. 1. FIG. 11 shows a diagram of an embossing device 101 similar to that described for example in U.S. Pat. No. 6,755,928.

The embossing device 101 comprises an embossing roller 103 provided with embossing protuberances 103P and rotating around an axis 103A. Shapes, dimensions and distribution of the embossing protuberances 103P of the embossing roller 103 may be similar to those described with reference to the embossing protuberances 3P of the embossing roller 3 of the previous embodiment (FIG. 1).

The embossing roller 103 co-acts with a pressure roller 105, provided for example with an elastically yielding coating 105R. The embossing roller 103 and the pressure roller 105 define an embossing nip 107, through which a first ply V1 of cellulose fibers is fed. Downstream of the embossing nip 107, an applicator 109 is provided around the embossing roller 103, the applicator being adapted to apply a functional fluid to the ply V1 fed around the embossing roller 103. The applicator 109 comprises a functional fluid dispenser 109.1, a screen roller 109.2 receiving the functional fluid from the dispenser 109.1 and transferring it to a plate roller 109.3. This latter transfers the functional fluid to defined areas of the ply V1 fed around the embossing roller 103. All occurs substantially similarly to what described with reference to the embossing roller 3 and the functional fluid applicator 15.

Downstream of the applicator 109, a ply-bonding rotating element 21 is provided around the embossing roller 103, this element being substantially equal to the ply-bonding rotating element 21 described above with reference to FIGS. 1 and 2. The embossing roller 103 constitutes an anvil rotating element for the ply-bonding rotating element 21. Together with the ply V1, also a second ply V2 is fed in the bonding nips defined between each series of rollers 21.1 and 21.5 of the ply-bonding rotating element 121 and the embossing roller 103. The operation of the embossing unit 101 is substantially the same described with reference to the embossing device 1, except that the second ply V2 is not embossed, and therefore the second embossing roller and the second pressure roller are not provided.

In some embodiments, along the one, the other, or both the feed path of the plies V1 and V2 towards the embossing roller 103, a micro-embossing unit is provided for embossing one or the other or both the plies V1 and V2 before they arrive to the embossing roller 103.

FIG. 11 shows a first micro-embossing unit 151 along the path of the ply V1. The first micro-embossing unit 151 comprises a micro-embossing roller 153 provided with protuberances 153P, shown in the enlargement. The micro-embossing roller 153 co-acts with a pressure roller 155 that can be provided with an elastically yielding coating 155R. FIG. 11 also shows a second micro-embossing unit 157 along the path of the ply V2. The second micro-embossing unit 157 comprises a micro-embossing roller 159, provided with protuberances 159P shown in the enlargement. The micro-embossing roller 159 co-acts with a pressure roller 161, that can be provided with an elastically yielding coating 161R.

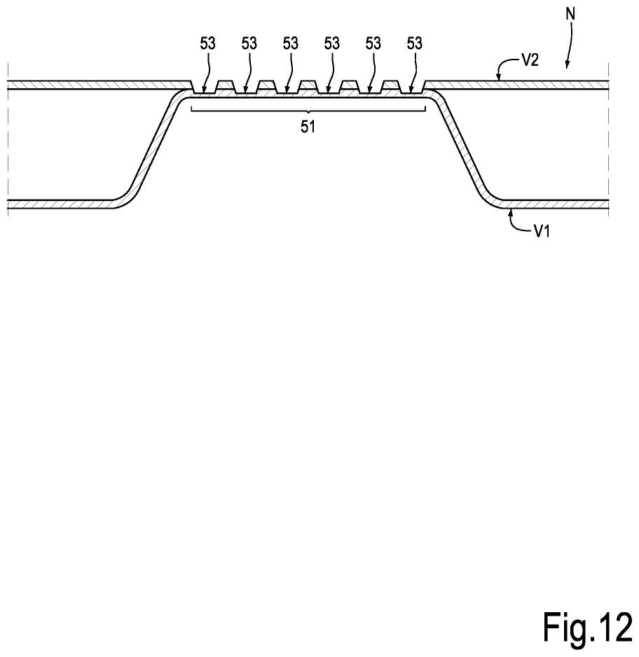

The product obtained can be a multi-ply web material N, where the single plies V1 and V2 may be micro-embossed, or may be not embossed. FIG. 12 schematically shows the web material N that can be obtained through the embossing device 101 of FIG. 11, without micro-embossing. The structure of the web material N is substantially equal to that of FIG. 9, but without embossing the ply V2.

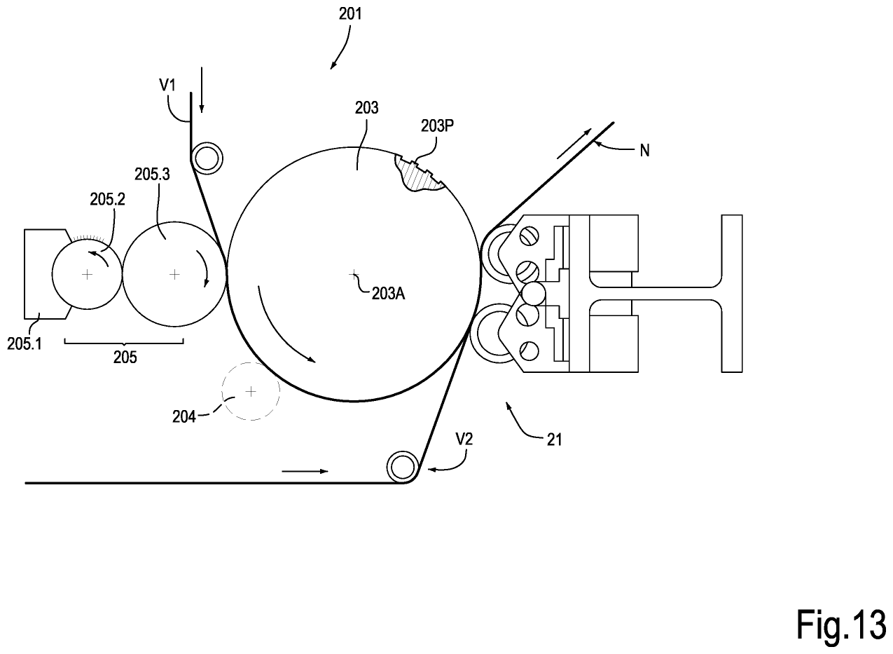

By keeping the main features of the method and device for autogenous mechanical ply-bonding described above, many variants can be adopted of the configuration of the device and the corresponding operation method. Some of these variants will be now described with reference to FIGS. 13 to 16.

FIG. 13 shows a device 201 comprising an engraved roller 203 that rotates around a rotation axis 203A and is provided with protuberances 203P on the cylindrical surface. The roller 203 may be an embossing roller but, as it will be clearly apparent from the description below, it could even not perform embossing action. The engraved roller 203 co-acts with a functional fluid applicator 205. In some embodiments, the applicator 205 is omitted or deactivated. The applicator 205 comprises a dispenser 205.1 for supplying functional fluid, a screen roller 205.2, and a plate roller 205.3 transferring the functional fluid, supplied by the dispenser 205.1, to a ply V1 fed towards the engraved roller 203. A ply-bonding rotating element, indicated also in this case with number 21, is provided around the engraved roller 203, downstream of the applicator 205, realized as described above with reference to FIGS. 1 and 2. The engraved roller 203 forms an anvil rotating element for the ply-bonding rotating element 21. In the embodiment of FIG. 13, a first ply V1 is fed around the plate roller 205.3 to receive functional fluid. In the nip between the plate roller 205.3 and the engraved roller 203, the ply V1 is transferred to the engraved roller 203 and fed therefrom to the nips defined by the series of rollers 21.1 and 21.5. In these nips, the ply V1 is bonded to a second ply V2, which is directly fed between the rollers 21.1 and the engraved roller 203. In this embodiment, if a functional fluid is used, it is applied to the ply V1 before transferring this latter to the engraved roller 203. The functional fluid may be applied to the whole surface of the ply V1. Alternatively, the plate roller 205.3 may have a cylindrical surface with a raised pattern, similarly to what occurs in printing plate rollers. In this case, the functional fluid is transferred from the plate roller to limited areas of the ply V1, according to a pattern coinciding with the raised surface of the plate roller. The functional fluid may be colored or colorless. In some embodiments, functional fluids of different colors are used.

In a modified embodiment, the device 201 comprises a pressure roller 204, provided with an elastically yielding coating, not shown, made for example of natural or synthetic rubber, analogously to the pressure rollers described above. In this case, the ply V1 is embossed before being bonded to the ply V2 by means of mechanical autogenous bonding through the ply-bonding rotating element 21.

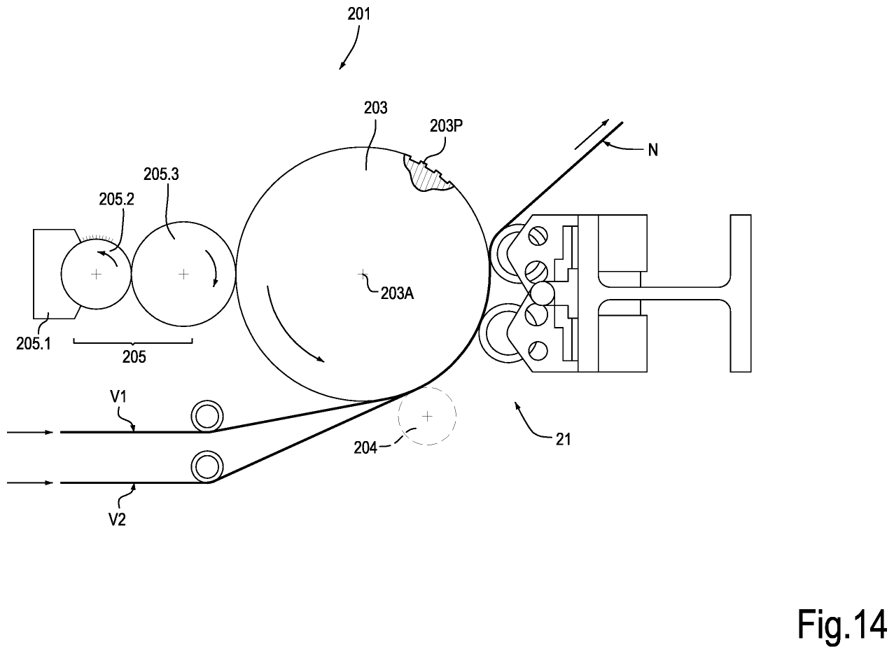

FIG. 14 shows a further embodiment of a device for bonding plies V1 and V2, indicated with the reference number 201 again. The same numbers indicate identical or equivalent parts to those illustrated in FIG. 13 and described above. In the embodiment of FIG. 14, both the plies V1 and V2 are fed to the engraved roller 203 downstream of the applicator 205. The plate roller 205.3 supplies the functional fluid onto the protuberances 203P of the engraved roller 203. The functional fluid is then transferred to the cellulose fibers of the plies V1 and V2 when these latter are brought into contact with the engraved roller 203. In the embodiment of FIG. 14, the two plies V1 and V2 are fed along separate paths that overlap only in the touching point with the engraved roller 203. However, this is not necessary. The two plies V1 and V2 may be fed, for instance, along a common path.

A pressure roller 204 is provided also in the embodiment of FIG. 14, which is coated with an elastically yielding material, for embossing together the two plies V1 and V2 on the engraved roller 203. In other embodiments, the plies V1 and V2 are fed to the engraved roller 203 in different positions, and the pressure roller 204 is so arranged as to emboss only the ply V1, or two pressure rollers may be provided for embossing firstly the ply V1 and then the two plies V1 and V2 together.

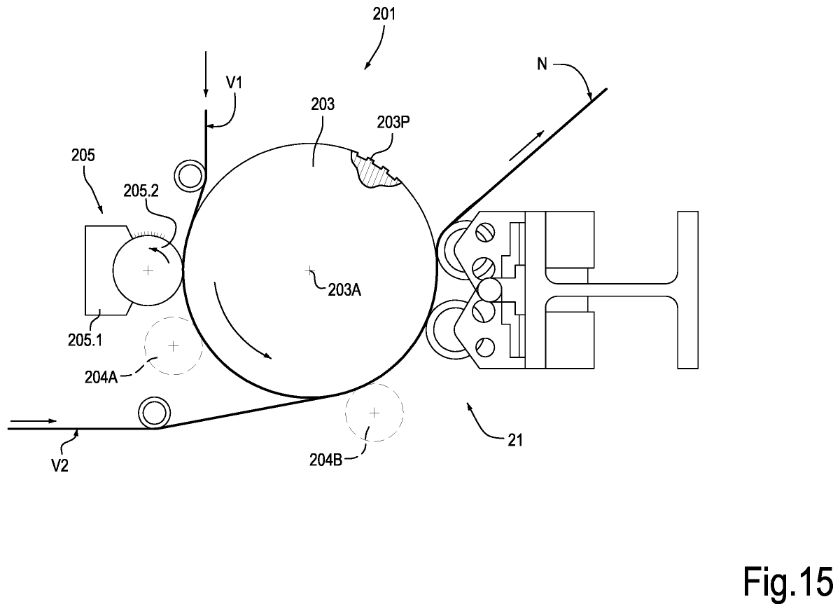

FIG. 15 shows a further embodiment of the device 201. In this case, the functional fluid applicator 205 comprises a dispenser 205.1 and a screen roller 205.2, but it is devoid of plate roller. The screen roller 205.2 transfers the functional fluid directly to the ply V1 or to the engraved roller 203. This configuration of the applicator 205 is simpler, even if less efficient, and may be used also in the remaining embodiments described herein. Similarly, the device 201 of FIG. 15 may be provided with an applicator 205 comprising a plate roller, as described in the other embodiments.

In the device of FIG. 15, the first ply V1 is fed around the engraved roller 203 and is then transferred therefrom to the nip between the engraved roller 203 and the applicator 205, in order to receive functional fluid in areas corresponding to the heads of the protuberances 203P. The ply V2 is fed downstream of the applicator 205. The two plies V1 and V2, put over each other, are fed from the engraved roller 203 to the bonding nips between the engraved roller 203 and the ply-bonding rotating element 21.

A broken line indicates two pressure rollers 204A, 204B that can be provided as an alternative, or in combination, or omitted. Each of the pressure rollers 204A, 204B, if any, is coated with an elastically yielding material to emboss the ply V1 and/or both plies V1 and V2, acting against the engraved roller 203, around which the plies V1 and V2 are fed.

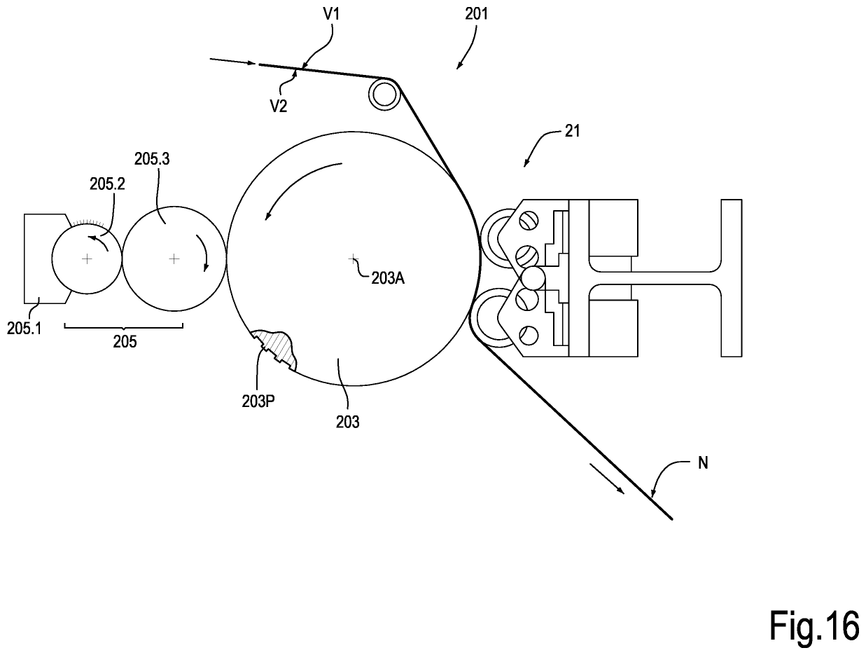

FIG. 16 shows a further version of the device of FIG. 14, differing therefrom in the different arrangement of the paths of the plies V1 and V2 and in the rotation direction of the rollers. In FIG. 16 the plies V1 and V2 are fed directly in the nip between the engraved roller 203 and the ply-bonding rotating element 21. The functional fluid is applied by the applicator 205 to the head surfaces of the protuberances 203R.

As it is clearly understood from the various embodiments illustrated herein, through the described methods and the devices it is possible to have a correct and efficient mutual bonding of the plies without the need for any step between the ply-bonding rotating element and the anvil rotating element. In fact, the respective protuberances are so arranged that there is always a plurality of autogenous bonding spots at the protuberances of the anvil element.

The embodiments described above are mere non-limiting examples of the features of the invention. Many further variants are possible both in terms of structure of the device and steps of the method, without however departing from the scope of the invention as claimed in the attached claims. For example, the ply-bonding rotating element 21 described in the previous embodiments is particularly advantageous, as it allows both to apply bonding pressure on the whole width of the plies V1, V2, and to distribute more advantageously the mechanical stresses on the anvil roller, constituted, in the various embodiments described above, by the embossing roller 3, by the embossing roller 103, or by the engraved roller 203.

However, in currently less preferred embodiments, instead of two series of rollers 21.1 and 21.5, offset with respect to one another (FIG. 2), it is possible to use a single engraved roller, whose length (axial dimension) is substantially equal to the length of the anvil roller 3, 103, 203. In further embodiments, it is possible to distribute the protuberances 31 on more than two series of coaxial rollers, for example three, or four, or even more series of rollers, wherein the rollers of each series are coaxial with one another, and the rollers of the various series are offset in axial direction so that the whole cylindrical surface of the anvil roller 3, 103, 203 co-acts with protuberances 31 of at least one of the rollers 21.1, 21.5.

Other alternatives are possible for the head surfaces 3.1P of the embossing protuberances 3P of the embossing roller 3 or of any other anvil roller, for example the embossing roller 103 or the engraved roller 203. In the description above, the head surface 3.1P is a substantially smooth surface, theoretically lying on a cylindrical geometrical surface constituting the envelope of the protuberances of the anvil roller. However, it is also possible to provide the head surface of the protuberances of the anvil roller with a series of projections of limited dimensions. An embodiment of this type of protuberances is described in DE-202014003638. In this case, the head surfaces of the protuberances have projections radially projecting from the head surface, so as to reduce the overall area where the protuberances 31 of the rollers 21.1 and 21.5 exert pressure. The local pressure increases without increasing the total load applied to the rollers.

Further variants are possible of the shape of the embossing protuberances 3P of the embossing roller 3 or of any other anvil roller, for example the embossing roller 103 or the engraved roller 203. The sides of the protuberances 3P may be inclined differently and/or may have a variable inclination with respect to the rotation axis of the embossing roller 3, 103, 203, as disclosed in EP2699413.

In improved embodiments of the invention, the rollers 3, or any other anvil roller, for example the embossing roller 103 or the engraved roller 203, may be heated. The rollers may be heated through a hot fluid such as steam, oil or the like. Alternatively, the rollers may be heated electrically, through an inner resistance, or externally through electro-magnetic induction. Also, the rollers 21.1 and 21.5 may be heated, preferably through magnetic induction.

In general, it is possible to heat both the rollers 21.1, 21.5, and the corresponding anvil roller (103, 3), or only the anvil roller or only the rollers 21.1, 21.5. By heating the rollers, in combination with the application of functional fluid if necessary, the adhesion of the plies in the bonding spots 53 is facilitated and improved. The temperature of the rollers may be comprised between 80° C. and 250° C., preferably between 100° C. and 200° C. The rollers may be heated independently of the supply of water-based functional fluid to the ply V1. In this case, in addition to an improved adhesion, it is possible to have lower residual humidity of the multi-ply cellulose web material. In a possible modified embodiment, in order to avoid the use of functional fluid or to limit the quantity thereof, thanks to the heating of rollers it is possible to feed the plies directly with a humidity content greater than that of the prior art. Usually, the humidity content of the plies of cellulose fibers fed to the bonding device is equal to, or lower than, about 15%, preferably equal to, or lower than about 6%.

The rollers 21.1, 21.5 of the ply-bonding rotating element 21 may be pressed with the respective cylindrical surfaces (or more exactly with the head surfaces of the respective protuberances 31) against the cylindrical surface of the corresponding anvil rotating element, for example of the embossing roller 3, or more precisely against the head surfaces of the protuberances, with which this anvil rotating element is provided. In further embodiments, the head surfaces of the two opposite rotating elements (bonding element and anvil element) are not pressed against one another, and are kept at a mutual distance lower than the sum of the thicknesses of the plies V1 and V2. This can be obtained, for instance, by providing rest abutments for the rollers 21.1, 21.5 forming the ply-bonding rotating element.

Having illustrated some embodiments of the invention, features of the subject matter disclosed herein will be listed below:

Clausola 1. A method for producing a multi-ply cellulose web material, comprising the following steps:
making at least a first ply of cellulose fibers and a second ply of cellulose fibers, put over each other, pass through a lamination nip of a pressure ply-bonding device, the lamination nip being defined between:
   a ply-bonding rotating element having at least one cylindrical surface with a plurality of first protuberances extending from said at least one cylindrical surface, each first protuberance having a side surface and a head surface;
   an anvil rotating element, having a cylindrical surface with a plurality of second protuberances extending from said cylindrical surface, each second protuberance having a side surface and a head surface; wherein the head surfaces of the second protuberances have multiple extension with respect to an extension of the head surfaces of the first protuberances;
pressing the head surfaces of at least some of said first protuberances against each head surface of the second protuberances in the lamination nip and bonding by pressure the plies of cellulose fibers forming ply-bonding areas corresponding to the head surfaces of the second protuberances, each ply-bonding area comprising a plurality of bonding spots corresponding to the head surfaces of the first protuberances.

Clausola 2. The method of clause 1, wherein the anvil element is a roller.

Clausola 3. The method of clause 2, wherein the roller is a metal roller.

Clausola 4. The method of clause 1, 2 or 3, wherein the ply-bonding rotating element comprises a first series of approximately coaxial rollers, each of which is provided with a cylindrical surface provided with said first protuberances, wherein the axis of the first series of approximately coaxial rollers is approximately parallel to the rotation axis of the anvil rotating element.

Clausola 5. The method of clause 4, wherein the ply-bonding rotating element comprises a second series of approximately coaxial rollers, each of which is provided with a cylindrical surface provided with said first protuberances, and wherein the first series of rollers and the second series of rollers have axes parallel to one another and spaced around a circumference of the anvil rotating element.

Clausola 6. The method of clause 5, wherein: the first series of rollers comprises rollers that are spaced from one another along the respective rotation axis; the second series of rollers comprises rollers that are spaced from one another along the respective rotation axis; and wherein the rollers of the first series are offset with respect to the rollers of the second series, so that the rollers of the second series are interposed between the rollers of the first series.

Clausola 7. The method of clause 5 or 6, wherein each said roller of the ply-bonding rotating element comprises a respective pressure actuator.

Clausola 8. The method of clause 1 or 2, wherein the ply-bonding rotating element comprises a single rotating roller provided with a cylindrical surface provided with said first protuberances, with a rotation axis approximately parallel to the rotation axis of the anvil rotating element.

Clausola 9. The method of one or more of the previous clauses, wherein the plies of cellulose fibers are driven around the anvil rotating element and pressed by the first protuberances against the head surfaces of the second protuberances, without embossing the plies.

Clausola 10. The method of clause 9, wherein at least one of the plies of cellulose fibers is micro-embossed.

Clausola 11. The method of one or more of the previous clauses, wherein the maximum dimension of the head surfaces of the first protuberances is comprised between about 0.1 mm and about 1.5 mm, preferably between about 0.15 mm and about 0.7 mm, in particular between about 0.2 mm and about 0.6 mm.

Clausola 12. The method of one or more of the previous clauses, wherein the density of the first protuberances is comprised between about 20 and about 200 protuberances/cm², preferably between about 50 and about 170 protuberances/cm².

Clausola 13. The method of clause 12, wherein the first protuberances are distributed with uniform density, preferably according to a pattern made of polygonal, preferably quadrangular, meshes, wherein the first protuberances are arranged at the vertexes of said polygonal meshes.

Clausola 14. The method of one or more of the previous clauses, wherein the whole area of the head surfaces of the second protuberances is comprised between about 1% and about 30% of the cylindrical surface of the anvil rotating element.

Clausola 15. The method of one or more of the previous clauses, wherein the plies are bonded together by means of uniformly distributed ply-bonding.

Clausola 16. The method of one or more of the previous clauses, comprising the step of applying a non-adhesive fluid, preferably a water-based fluid, to areas of at least one of said plies of cellulose fibers, said fluid promoting pressure ply-bonding between the plies of cellulose fibers.

Clausola 17. The method of one or more of the previous clauses, comprising the step of embossing at least one of said plies of cellulose fibers between the anvil rotating element and a pressure roller having an elastically yielding surface, wherein the anvil rotating element and the pressure roller define, therebetween, an embossing nip, arranged upstream of the lamination nip along the path of the plies of cellulose fibers.

Clausola 18. The method of one or more of the previous clauses, comprising the step of heating the anvil rotating element and/or the ply-bonding rotating element up to a temperature comprised between about 80° C. and about 250° C., preferably between about 100° C. and about 200° C.

Clausola 19. The method of one or more of the previous clauses, wherein the humidity content of at least one of the two paper plies is greater than 6%.

Clausola 20. A device for producing a multi-ply cellulose web material comprising a plurality of plies of cellulose fibers bonded together by autogenous bonding; wherein the device comprises:
a ply-bonding rotating element having at least one cylindrical surface with a plurality of first protuberances extending from said at least one cylindrical surface, each first protuberance having a side surface and a head surface;
an anvil rotating element, having a cylindrical surface with a plurality of second protuberances extending from said cylindrical surface, each second protuberance having a side surface and a head surface; wherein the head surfaces of the second protuberances have multiple extension with respect to an extension of the head surfaces of the first protuberances; wherein the anvil rotating element and the ply-bonding rotating element form at least one lamination nip, through which a feeding path for said plies of cellulose fibers extends;
pressure members for pressing the anvil rotating element and the ply-bonding rotating element against each other, so that between the first protuberances and the second protuberances a pressure is generated, adapted to promote the autogenous bonding of the plies of cellulose fibers.

Clausola 21. The device of clause 20, wherein the anvil element is a roller, preferably a metal roller.

Clausola 22. The device of clause 20 or 21, wherein the ply-bonding rotating element comprises a first series of coaxial rollers, each of which is provided with a cylindrical surface provided with said first protuberances, wherein the axis of the first series of approximately coaxial rollers is approximately parallel to the rotation axis of the anvil rotating element.

Clausola 23. The device of clause 22, wherein the ply-bonding rotating element comprises a second series of approximately coaxial rollers, each of which is provided with a cylindrical surface provided with said first protuberances, and wherein the first series of rollers and the second series of rollers have axes parallel to one another and spaced around a circumference of the anvil rotating element.

Clausola 24. The device of clause 22 or 23, wherein each of said rollers of the ply-bonding rotating element comprises a respective pressure actuator.

Clausola 25. The device of clause 24, wherein: the first series of rollers comprises rollers that are spaced from one another along an alignment direction; the second series of rollers comprises rollers that are spaced from one another along an alignment direction; and wherein the rollers of the first series are offset with respect to the rollers of the second series, so that the rollers of the second series are interposed between the rollers of the first series.

Clausola 26. The device of clause 20 or 21, wherein the ply-bonding rotating element comprises a single rotating roller provided with a cylindrical surface provided with said first protuberances, with a rotation axis approximately parallel to the rotation axis of the anvil rotating element.

Clausola 27. The device of one or more of clauses 20 to 26, comprising at least one micro-embossing unit.

Clausola 28. The device of one or more of clauses 20 to 26, wherein the maximum dimension of the head surfaces of the first protuberances is comprised between about 0.1 mm and about 1.5 mm, preferably between about 0.15 mm and about 0.7 mm, in particular between about 0.2 mm and about 0.6 mm.

Clausola 29. The device of one or more of clauses 20 to 28, wherein the density of the first protuberances is comprised between about 20 and about 200 protuberances/cm², preferably between about 50 and about 170 protuberances/cm².

Clausola 30. The device of clause 29, wherein the first protuberances are distributed with uniform density, preferably according to a pattern made of polygonal, preferably quadrangular, meshes, wherein the first protuberances are arranged at the vertexes of said polygonal meshes.

Clausola 31. The device of one or more of clauses 20 to 30, wherein the whole area of the head surfaces of the second protuberances is comprised between about 1% and about 30% of the active cylindrical surface of the anvil rotating element.

Clausola 32. The device of one or more of clauses 20 to 31, wherein the distribution of the protuberances of the anvil rotating element are such as to generate a uniform ply-bonding of the plies of cellulose fibers.

Clausola 33. The device of one or more of the previous clauses, comprising an applicator for applying a non-adhesive functional fluid, adapted to apply directly or indirectly said functional fluid on at least one ply of cellulose fibers.

Clausola 34. The device of one or more of clauses 20 to 33, comprising a pressure roller having an elastically yielding surface, wherein the anvil rotating element and the pressure roller define an embossing nip therebetween, arranged upstream of the lamination nip along the path of the plies of cellulose fibers.

Clausola 35. The device of one or more of clauses 20 to 34, comprising members for heating the anvil rotating element and/or the ply-bonding rotating element.

Clausola 36. A sheet product comprising a plurality of plies of cellulose fibers that are bonded together by means of autogenous bonding, wherein autogenous bonding spots are grouped into discrete ply-bonding areas, spaced from one another.

Clausola 37. The product of clause 36, wherein at least one of the plies of cellulose fibers is micro-embossed.

Clausola 38. The product of clause 36 or 37, wherein the maximum dimension of the bonding spots is comprised between about 0.1 mm and about 1.5 mm, preferably between about 0.15 mm and about 0.7 mm, in particular between about 0.2 mm and about 0.6 mm.

Clausola 39. The product of one or more of clauses 36 to 38, wherein the density of the bonding spots in the ply-bonding areas is comprised between about 20 and about 200 protuberances/cm², preferably between about 50 and about 170 protuberances/cm².

Clausola 40. The product of clause 39, wherein the bonding spots in the ply-bonding areas are distributed with uniform density, preferably according to a pattern made of polygonal, preferably quadrangular, meshes, wherein the first protuberances are arranged at the vertexes of said polygonal meshes.

Clausola 41. The product of one or more of clauses 37 to 40, wherein the sum of the surfaces of the ply-bonding areas is comprised between about 1% and about 30% of the whole surface of the product.

Clausola 42. The product of one or more of clauses 37 to 41, wherein the plies are bonded together by means of a uniformly distributed ply-bonding.

Clausola 43. The product of one or more of clauses 37 to 42, wherein at least a first ply of said plies of cellulose fibers is embossed and has a first series of embossed projections facing a second ply of said plies of cellulose fibers; wherein the embossed projections have head surfaces into contact with the second ply of cellulose fibers; and wherein the autogenous bonding spots are grouped on the head surfaces of the embossed projections of the first ply of cellulose fibers.

1-31. (canceled)

32. A method for producing a multi-ply cellulose web material, comprising steps as follows:
passing at least a first ply of cellulose fibers and a second ply of cellulose fibers, positioned over each other, through a lamination nip of a pressure ply-bonding device, the lamination nip being defined between:
a ply-bonding rotating element comprising a first series of substantially coaxial rollers, each of which is provided with a cylindrical surface with a plurality of first protuberances extending from the cylindrical surface, each of said first protuberances having a side surface and a head surface;
an anvil rotating element, having a cylindrical surface with a plurality of second protuberances extending from said cylindrical surface, each of said second protuberances having a side surface and a head surface; wherein the head surfaces of the second protuberances have multiple extension with respect to an extension of the head surfaces of the first protuberances; wherein the axis of the first series of substantially coaxial rollers is substantially parallel to the rotation axis of the anvil rotating element;
pressing the head surfaces of at least some of said first protuberances against the head surfaces of the second protuberances in the lamination nip and bonding by pressure the first ply and the second ply forming ply-bonding areas corresponding to the head surfaces of the second protuberances, each of said ply-bonding areas comprising a plurality of bonding spots corresponding to the head surfaces of the first protuberances; wherein the first ply and the second are driven around the anvil rotating element and pressed by the first protuberances against the head surfaces of the second protuberances, without embossing the plies.

33. The method of claim 32, wherein the anvil rotating element is an embossing roller, and wherein the embossing roller is associated with a pressure roller.

34. The method of claim 33, wherein the embossing roller forming the anvil rotating element is a metal roller.

35. The method of claim 32, wherein the ply-bonding rotating element comprises a second series of substantially coaxial rollers, each of which is provided with a cylindrical surface provided with said first protuberances, and wherein the first series of coaxial rollers and the second series of coaxial rollers have axes parallel to one another and spaced around a circumference of the anvil rotating element.

36. The method of claim 35, wherein the first series of coaxial rollers comprises rollers that are spaced from one another along a respective rotation axis; the second series of coaxial rollers comprises rollers that are spaced from one another along a respective rotation axis; and wherein the rollers of the first series of coaxial rollers are offset with respect to the rollers of the second series of coaxial rollers, so that the rollers of the second series of coaxial rollers are interposed between the rollers of the first series of coaxial rollers.

37. The method of claim 35, wherein each of said rollers of the ply-bonding rotating element comprises a respective pressure actuator.

38. The method of claim 32, wherein at least one of the first ply and the second ply is micro-embossed.

39. The method of claim 32, wherein the maximum dimension of the head surfaces of the first protuberances comprises between about 0.1 mm and about 1.5 mm.

40. The method of claim 32, wherein density of the first protuberances comprises between about 20 and about 200 protuberances/cm².

41. The method of claim 40, wherein the first protuberances are distributed with uniform density and according to a pattern of polygonal meshes, wherein the first protuberances are arranged at vertexes of the polygonal meshes.

42. The method of claim 32, wherein a whole area of the head surfaces of the second protuberances comprises between about 1% and about 30% of the cylindrical surface of the anvil rotating element.

43. The method of claim 32, wherein the first ply and the second ply are bonded together by uniformly distributed ply-bonding.

44. The method of claim 32, further comprising applying a non-adhesive fluid to areas of at least one of said first ply and said second ply to provide fluid promoting pressure ply-bonding between the first ply and the second ply.

45. The method of claim 32, further comprising embossing at least one of said first ply and said second ply between the anvil rotating element and a pressure roller having an elastically yielding surface, wherein the anvil rotating element and the pressure roller define therebetween an embossing nip arranged upstream of the lamination nip along a path of the first ply and the second ply.

46. The method of claim 32, further comprising heating the anvil rotating element and/or the ply-bonding rotating element up to a temperature comprising between about 80° C. and about 250° C.

47. The method of claim 32, wherein humidity content of at least one of the first ply and the second ply is greater than 6%.

48. A device for producing a multi-ply cellulose web material comprising a plurality of plies of cellulose fibers bonded together by autogenous bonding; wherein the device comprises:
a ply-bonding rotating element comprising a first series of substantially coaxial rollers, each of which is provided with a cylindrical surface with a plurality of first protuberances extending from said cylindrical surface, each of said first protuberances having a side surface and a head surface;
an anvil rotating element, having a cylindrical surface with a plurality of second protuberances extending from said cylindrical surface, each of said second protuberance having a side surface and a head surface; wherein the head surfaces of the second protuberances have multiple extensions with respect to an extension of the head surfaces of the first protuberances; wherein the anvil rotating element and the ply-bonding rotating element form at least one lamination nip, through which a feeding path for said first ply and said second ply extends; wherein an axis of the first series of substantially coaxial rollers is substantially parallel to a rotation axis of the anvil rotating element;
pressure members for pressing the anvil rotating element and the ply-bonding rotating element against each other, so that between the first protuberances and the second protuberances a pressure is generated, adapted to promote the autogenous bonding of the plies of cellulose fibers;
wherein the anvil rotating element and the ply-bonding rotating element are arranged so that plies of cellulose fibers passing through nips defined between the anvil rotating element and the rollers of the ply-bonding rotating element are not deformed by embossing.

49. The device of claim 48, wherein the anvil rotating element is an embossing roller associated with a pressure roller.

50. The device of claim 48, wherein the ply-bonding rotating element comprises a second series of substantially coaxial rollers, each of which is provided with a cylindrical surface provided with said first protuberances, and wherein the first series of coaxial rollers and the second series of coaxial rollers have axes parallel to one another and spaced around a circumference of the anvil rotating element.

51. The deice of claim 48, wherein each of said coaxial rollers of the ply-bonding rotating element comprises a respective pressure actuator.

52. The device of claim 51, wherein the first series of coaxial rollers comprises rollers that are spaced from one another along an alignment direction; the second series of coaxial rollers comprises rollers that are spaced from one another along an alignment direction; and wherein the coaxial rollers of the first series are offset with respect to the coaxial rollers of the second series, so that the coaxial rollers of the second series are interposed between the coaxial rollers of the first series.

53. The device of claim 48, comprising at least one micro-embossing unit.

54. The device of claim 48, wherein the maximum dimension of the head surfaces of the first protuberances comprises between about 0.1 mm and about 1.5 mm.

55. The device of claim 48, wherein density of the first protuberances comprises between about 20 and about 200 protuberances/cm².

56. The device of claim 55, wherein the first protuberances are distributed with uniform density according to a pattern of polygonal meshes, wherein the first protuberances are arranged at vertexes of said polygonal meshes.

57. The device of claim 48, wherein a whole area of the head surfaces of the second protuberances comprises between about 1% and about 30% of the active cylindrical surface of the anvil rotating element.

58. The device of claim 48, wherein distribution of the second protuberances of the anvil rotating element are such as to generate uniform ply-bonding of the plurality of plies of cellulose fibers.

59. The device of claim 48, further comprising an applicator for applying a non-adhesive functional fluid, adapted to apply directly or indirectly said functional fluid on at least one ply of cellulose fibers.

60. The device of claim 48, further comprising a pressure roller having an elastically yielding surface, wherein the anvil rotating element and the pressure roller define an embossing nip therebetween, arranged upstream of the lamination nip along a path of the plurality of plies of cellulose fibers.

61. The device of claim 48, further comprising members for heating the anvil rotating element and/or the ply-bonding rotating element.

62. The device of claim 48, further comprising a further embossing roller associated with a further pressure roller.
